(19) United States
(12) Patent Application Publication
(10) Pub. No.: US 2013/0255002 A1
(43) Pub. Date: Oct. 3, 2013

(54) UTILITY KNIFE MULTI-TOOL

(71) Applicant: STANLEY BLACK & DECKER, INC., New Britian, CT (US)

(72) Inventors: Brian KEERS, Terryville, CT (US); Karl VANDERBEEK, Germantown, OH (US); Stephen ROWLAY, Sheffield (GB)

(73) Assignee: STANLEY BLACK & DECKER, INC., New Britain, CT (US)

(21) Appl. No.: 13/794,092

(22) Filed: Mar. 11, 2013

Related U.S. Application Data
(60) Provisional application No. 61/616,699, filed on Mar. 28, 2012.
(60) Provisional application No. 61/635,084, filed on Apr. 18, 2012.

(51) Int. Cl. B25F 1/04

(52) U.S. Cl. CPC B25F 1/04
USPC 7/118

(57) ABSTRACT

A tool includes a housing and a slidable blade assembly configured to slidably move between first and second positions. The slidable blade assembly includes a blade stored within the housing when the blade assembly is in the first position, but has at least a portion thereof extending outwardly from the housing when the blade assembly is in the second position. The tool also includes a pivotable tool pivotally movable relative to the housing that is configured to pivotably move among a first locking position where a work end of the pivotable tool is received adjacent to the housing, a second locking position where the pivotable tool extends from the housing in a fully extended position, and a third locking position intermediate the first and second locking positions. A releasable lock assembly is arranged to selectively lock the pivotable tool in the first, second, or third locking positions.

This application claims priority and benefit under 35 U.S.C. §119(e) to U.S. Provisional Patent Application Ser. No. 61/616,699, filed Mar. 28, 2012, and to U.S. Provisional Patent Application Ser. No. 61/635,084, filed Apr. 18, 2012. Both of these applications are incorporated herein by reference in their entirety.

### FIELD OF THE INVENTION

The present invention relates generally to hand tools.

### BACKGROUND OF THE INVENTION

“Multi-tools” contain a plurality of tools in a single housing. Among other things, the present application relates to multi-tools having a housing containing both sliding and folding tools, with a locking mechanism to hold the folding tools in an extended or stored position.

### SUMMARY OF THE INVENTION

According to one aspect of this disclosure, a tool includes a housing and a slidable blade assembly configured to slidably move between a first position and a second position. The slidable blade assembly includes a blade. The blade is stored within the housing when the slidable blade assembly is in the first position, and the blade has at least a portion thereof extending outwardly from the housing when the slidable blade assembly is in the second position. The tool also includes a pivotable tool pivotally movable relative to the housing. The pivotable tool is configured to pivotably move among a plurality of locking positions including a first locking position where a work end of the pivotable tool is received adjacent to the housing, a second locking position where the pivotable tool extends from the housing in a fully extended position, and a third locking position intermediate the first and second locking positions. The tool further includes a releasable lock assembly arranged to selectively lock the pivotable tool in the first, second, or third locking positions.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only and are not a limitation of the invention. In addition, it should be appreciated that structural features shown or described in any one embodiment herein can be used in other embodiments as well. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

Features of the tool in accordance with one embodiment are shown in the drawings, in which like reference numerals designate like elements. The drawings form part of this original disclosure in which:

FIG. 1 is a perspective view of an embodiment of a multi-tool of the present invention including a slidable blade assembly and at least one pivotable tool;

FIG. 2 shows a perspective view of an opposite side of the embodiment of the multi-tool of FIG. 1;

FIG. 3 shows a reduced cross sectional side view of a front portion of the multi-tool of FIG. 1, illustrating a mechanism for extending and retracting the slidable blade assembly thereof;

FIG. 4 shows a reduced cross sectional side view of a front portion of the multi-tool of FIG. 1, opposite of that of FIG. 3;

FIG. 5 shows different embodiments of removable blade types which may be utilized in various embodiments of the multi-tool;

FIG. 6 shows a reduced cross sectional perspective view of the multi-tool of FIG. 1, illustrating a locking engagement is an isolated perspective view of a portion of the embodiment of FIG. 1, showing a locking aperture thereof;

FIG. 7 schematically illustrates the locking engagement of FIG. 6;

FIG. 8 illustrates a perspective view of another embodiment of a multi-tool of the present invention including storage for spare removable utility blades;

FIG. 9 illustrates a perspective view of another embodiment of a multi-tool of the present invention including pivotable storage for one or more spare removable utility blades, the pivotable storage being in a closed configuration; and

FIG. 10 illustrates a perspective view of the embodiment of the multi-tool of FIG. 9, with the pivotable storage being in an opened configuration.

### DETAILED DESCRIPTION OF THE ILLUSTRATED EMBODIMENT(S)

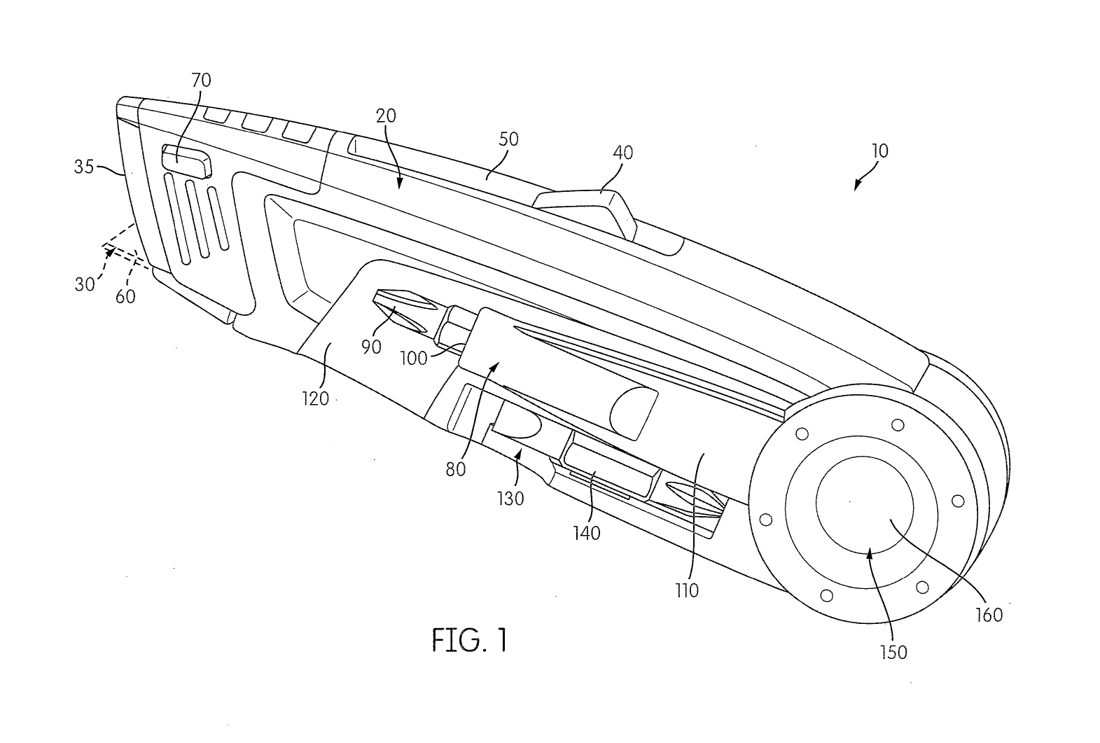

FIG. 1 shows an embodiment of a multi-tool 10 of the present invention. The multi-tool 10 comprises a housing 20 configured to hold a retractable slidable blade assembly 30 therein. Although described in greater detail below, it may be appreciated that the slidable blade assembly 30 may include both a cutting portion and structures associated therewith that slide relative to the housing 20. The slidable blade assembly 30 is configured to move between a first blade assembly position, wherein the cutting portion is entirely stored within the housing 20, and a second blade assembly position, wherein at least part of the cutting portion operably extends from a blade opening 35 at a front of the housing 20. Although the mechanics of the slidable blade assembly 30 may vary across embodiments, as described in greater detail below, in the illustrated embodiment the multi-tool 10 includes a thumb button 40 configured to extend out of a slot 50 provided along the top of the housing 20, extending along an orientation thereof. It may be appreciated that when the thumb button 40 is pulled in the slot 50 away from the blade opening 35, the slidable blade assembly 30 may be pulled into the blade opening 35, so as to be stored in the first assembly blade position, within the housing. When the thumb button 40 is pushed in the slot 50 towards the blade opening 35, however, the slidable blade assembly 30 may be pushed towards the second blade assembly position, extending from the housing 20 (i.e. out of the blade opening 35). When in the second blade assembly position, the housing 20 may be utilized as a handle for a user to hold onto to, so the user may operably utilize the cutting portion of the slidable blade assembly 30 to cut through a substrate or other surface.

As described in greater detail below, the slidable blade assembly 30 may vary across embodiments. Specifically, in some embodiments the cutting portion of the slidable blade assembly 30 may not be intended to be replaceable. In some such embodiments, the cutting portion may be generally of a thicker, stronger, or more rigid configuration, and may be suitable for sharpening a cutting edge thereof. In the illustrated embodiment, however, the slidable blade assembly 30 includes a removable utility blade 60, which contains the cutting portion of the slidable blade assembly 30, and may be selectively removed from the tool 10, so as to be replaced with a new (i.e. sharper) blade. Although the mechanism for removing the removable utility blade 60 from the slidable blade assembly 30 is described in greater detail below, it may be appreciated that in some embodiments, such as that illustrated, such removal may be facilitated by a blade release button 70 located on the housing 20.

Further shown in FIG. 1 is a pivotable tool 80 configured to pivot relative to the housing 20. As described in greater detail below, the pivotable tool 80 is configured to pivotably move among a plurality of locking positions. It may be appreciated that the plurality of locking positions include a first locking position, where a work end of the pivotable tool 80 is received adjacent to the housing 20, a second locking position, wherein the pivotable tool 80 extends from the housing 20 in a fully extended position, and a third locking position intermediate to the first and second locking positions. In the illustrated embodiment, where the pivotable tool 80 is a multi-bit screwdriver, configured to receive a bit 90 in a bit socket 100, it may be appreciated that the bit 90 in the bit socket 100 may constitute the work end of the pivotable tool 80, while a support arm 110 couples the work end to the housing 20.

In the illustrated embodiment, the housing 20 is shaped with a recessed region 120, such that the pivotable tool 80 may be received adjacent to the housing 20 when in the first locking position, so as to not uncomfortably protrude from the housing 20 into the hand of a user when the cutting portion of the slidable blade assembly 30 of the multi-tool 10 is being utilized. As further shown, in an embodiment where the pivotable tool 80 comprises a multi-bit screwdriver, the housing 20 may further be shaped to include a bit storage region 130. In some embodiments, such as that illustrated, the bit storage region 130 may include a recess configured to frictionally or snap-fit receive another bit 140. While the bit storage region 130 may comprise a generally open clip space, such as that shown, in other embodiments the bit storage region 130 may comprise a receiving slot similar to the bit socket 100. In an embodiment, the bit storage region 130 may also be pivotally mounted to the housing 20, such as by being formed on the pivotable tool 80, or by being formed as a separate pivotable body similar to the pivotable tool 80. In the illustrated embodiment, each of the bits 90, 140 are double sided (with one side of the bit 90 obscured in the bit socket 100). As such, the multi-bit screwdriver configuration of the pivotable tool 80 may have four operative bit heads (such as, but not limited to, different sizes and/or configurations of screwdriver). Accordingly, the bit storage region in some embodiments may be considered as part of the bit socket 100, holding the non-operative bit head therein. It may be appreciated that other configurations of bits may additionally or alternatively be utilized in various embodiments of the multi-tool 10.

Although the mechanism that facilitates movement of the pivotable tool 80 among the plurality of locking positions relative to the housing 20 is described in greater detail below, it may be appreciated that in an embodiment a releasable lock assembly may be arranged to lock the pivotable tool 80 into one of the plurality of locking positions. In the illustrated embodiment, the locking assembly includes a locking actuator 150, wherein engagement thereof by a user of the multi-tool 10 selectively allows pivoting movement of the pivotable tool 80 among the plurality of locking positions. Specifically, in the illustrated embodiment the locking actuator 150 includes a button 160 which when depressed, unlocks the pivotable tool 80, allowing the pivoting movement thereof, as described below.

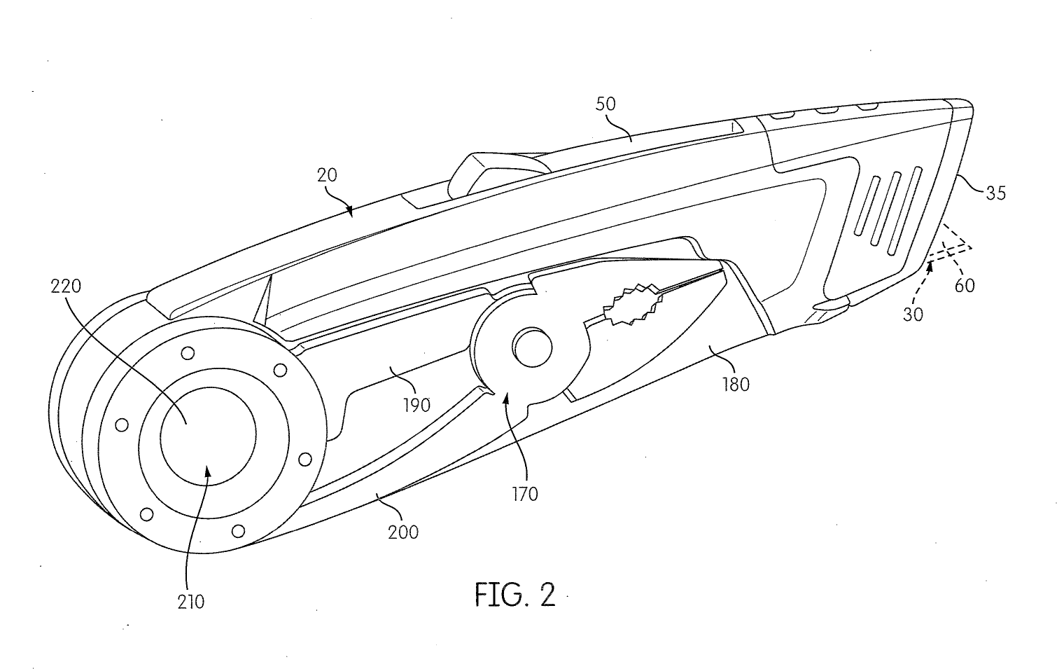

While in some embodiments the multi-tool 10 may include as tools only the slidable blade assembly 30 and a single pivotable tool, such as the pivotable tool 80 visible in FIG. 1, in other embodiments additional pivotable tools may additionally or alternatively be pivotally mounted to the housing 20, configured to pivotally move among an associated plurality of locking positions. For example, FIG. 2 illustrates another perspective of the multi-tool 10 (specifically the opposite face of the housing 20 from FIG. 1). In the view of FIG. 2, a second pivotable tool 170 is visible, which in the illustrated embodiment is a pair of pliers. As shown, the housing 20 may also be shaped with a recessed region 180, which analogously to the recessed region 120 may be configured such that the second pivotable tool 170 may be received adjacent to the housing 20 when in an associated first locking position. In the illustrated embodiment where the second pivotable tool 170 is a pair of pliers, it may be appreciated that a first plier handle 190 may be pivotally coupled to the housing 20, and thus may be locked in one of the plurality of locking positions for the second pivotable tool 170, while the other plier handle 200 may be configured to pivot relative to the first plier handle to allow for operation of the pliers.

While in some embodiments having multiple pivotable tools, such as the pivotable tool 80 and the second pivotable tool 170, a single locking actuator may lock or unlock pivotal motion of each of the pivotable tools, in the illustrated embodiment the second pivotable tool 170 is coupled to a second locking actuator 210, which is associated with the locking actuator 150, as described in greater detail below. As shown in the illustrated embodiment, the second locking actuator 210 includes a second button 220 which when depressed, unlocks the second pivotable tool 170, allowing the pivoting movement thereof, as described below.

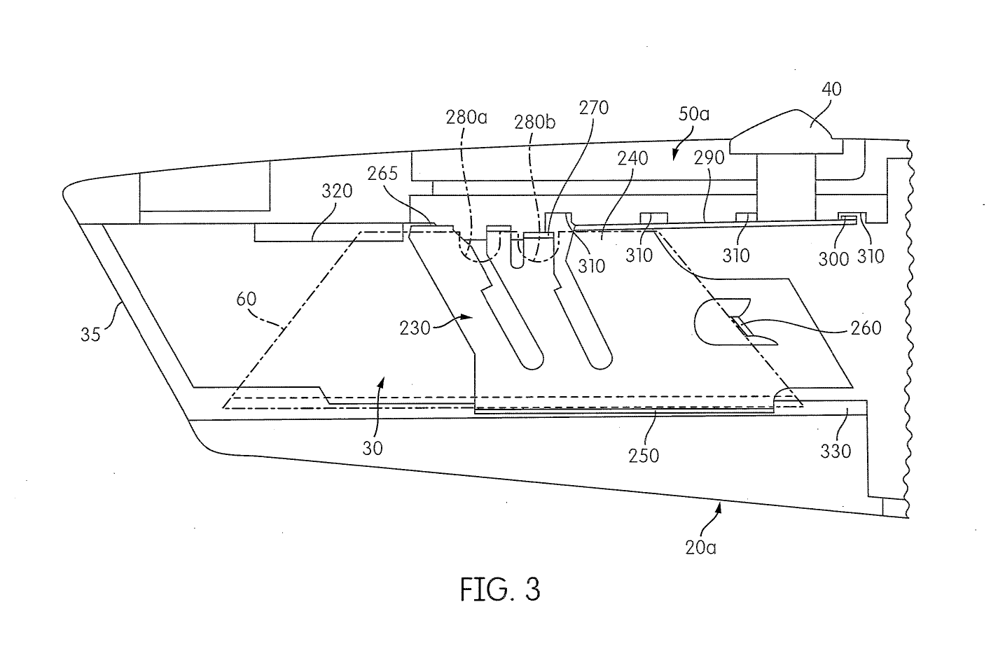

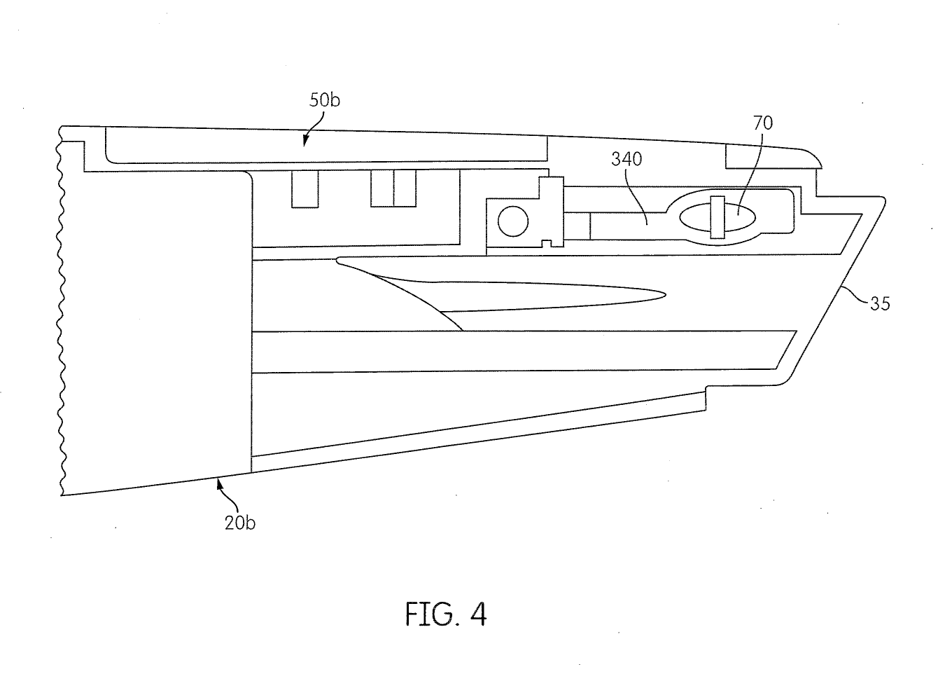

FIGS. 3-5 illustrate different cross-sectional views of the embodiment of the multi-tool 10, so as to illustrate the operation of the components thereof. Specifically, FIGS. 3 and 4 illustrate cross sectional views of a front portion of the multi-tool 10, showing opposing views of an interior thereof. FIG. 3 illustrates the interior of a first half 20a of the housing 20. As shown, the first half 20a includes an associated half 50a of the slot 50, through which extends the thumb button 40. As shown, the thumb button 40 is coupled to a movable blade support 230 configured to carry the removable utility blade 60. As shown, in an embodiment a planar portion 240 may extend alongside a portion of the removable utility blade 60, and may provide lateral retention and support for the removable utility blade 60. A lower flange 250 may extend from the planar portion 240, so as to provide a surface underneath the removable utility blade 60 for the removable utility blade 60 to rest on. Additionally, a rear flange 260 may extend in the same direction as the lower flange 250, to provide a surface against which the removable utility blade 60 may abut, and may act as a stopper when a replacement removable utility blade 60 is inserted into the movable blade support 230. In some embodiments, such as that illustrated, the movable blade carrier 230 may further include an upper flange 265 extending from the planar portion 240, which may prevent upward movement of the removable utility blade 60 when it is engaging a substrate. Furthermore, a blade engaging protrusion 270 may extend outward from the planar portion 240, or other portion of the movable blade support 230, and may engage with a notch in the removable utility blade 60. For example, in the illustrated embodiment, the removable utility blade 60 includes a notch 280a associated with a first side of the removable utility blade 60, and a notch 280b associated with a second side of the removable utility blade 60. It may be appreciated that the removable utility blade 60 may thus be configured to be rotated after extensive use, so that the blade engaging protrusion 270 engages a different one of the notch 280a and the notch 280b.

With the removable utility blade 60 fixedly coupled to the movable blade support 230, it may move between the first blade assembly position and second blade assembly position through slidable movement of the movable blade support 230. As shown in the illustrated embodiment, the thumb button 40 may be coupled to a resilient button arm 290 that couples to the planar portion 240 of the movable blade support 230. In an embodiment, the button arm 290 also includes a latching tab 300 which may be received in one of a plurality of notches 310 provided in the housing 20, associated with a plurality of extended (or fully retracted) positions for the slidable blade assembly 30. In some such embodiments, the latching tab 300 may be biased into the notches 310, such as by the button arm 290, or by any other appropriate mechanism. By depressing the thumb button 40, the latching tab 300 may be moved out of the notch 310, allowing relative movement of the movable blade support 230 relative to the housing 20. In the illustrated embodiment, the movable blade support 230 is slidably positioned between an upper guide structure 320 and a lower guide structure 330, which may form a channel that limits vertical movement of the movable blade support 230 relative to the housing 20.

As indicated above, in some embodiments removal of the removable utility blade 60 from the movable blade support 230 may be facilitated by the blade release button 70. FIG. 4 illustrates the interior of a second half 20b of the housing 20. As shown, the blade release button 70 extends through an aperture in the second half 20b, and may be coupled to a support arm 340 having one end secured to the interior of the second half 20b. The support arm 340 may bias the blade release button 70 through the aperture, so that the blade release button typically does not extend into the path of the movable blade support 230. When the moveable blade support 230 and the removable utility blade 60 thereof are in the second position, extending from the blade opening 35 of the housing 20, the blade release button 70 may be pressed by the user, to pivot part of the support arm 340 into the movable blade support 230, so as to move the blade engaging protrusion 270 in a direction away from the removable utility blade 60. The blade engaging protrusion 270 may therefore be pushed out of the notch 280a or 280b (depending on the orientation of the removable utility blade 60). Without such engagement, the removable utility blade 60 may then be removed from the movable blade support 230. While other slidable blade and blade release mechanisms may be utilized in other embodiments, another detailed description of a slidable blade (together with its support and associated structures) and the release mechanism is provided in U.S. Pat. No. 6,192,589, the entirety of which is hereby incorporated by reference.

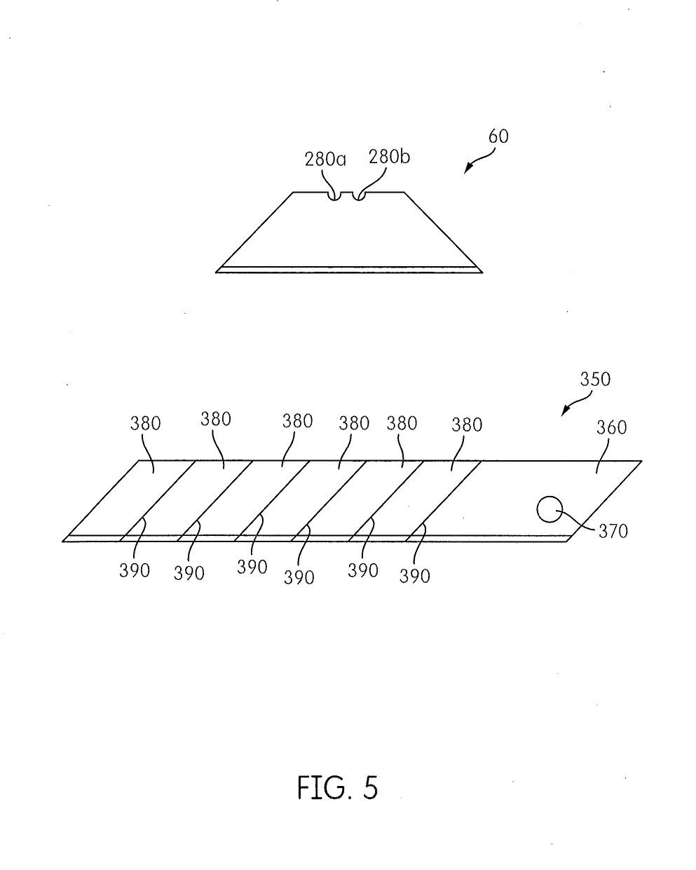

FIG. 4 further illustrates a second half 50b of the slot 50, which may couple with the first half 50a to form the slot 50 through which the thumb button 40 extends. It may be appreciated that other structures, configurations, or mechanisms operating the slidable blade assembly 30 may alternatively be utilized in other embodiments. For example, while in the illustrated embodiment the slidable blade assembly 30 is configured to utilize a standard trapezoidal configuration of the removable utility blade 60, in other embodiments the slidable blade assembly 30 may be configured to utilize different blade configurations. For example, FIG. 5 illustrates the removable utility blade 60 having a trapezoidal configuration with the pair of associated notches 280a and 280b, configured such that the removable utility blade 60 may be reversible, so that an opposite end of the removable utility blade 60 may be utilized when a first end dulls. FIG. 5 further illustrates a snap-off utility blade 350, which may be utilized in variants of the utility tool 10. As shown, the snap-off utility blade 350 includes a support portion 360 including a tool engagement portion 370. It may be appreciated that the tool engagement portion 370 may include a feature formed in the blade support portion 360, such as an aperture or hook, which may fixedly engage an embodiment of the movable blade support 230. Extending from the blade support portion 360 are a plurality of snap off blade portions 380 coupled to one another through structurally weak couplings 390. When an operative one of the snap off blade portions 380, distal from the support portion 360, becomes dull, a user may break the snap-off blade portion 380 at the structurally weak coupling 390, so as to use the subsequent snap-off blade portion as the operative blade portion. Again, other blade configurations may alternatively be utilized in other embodiments.

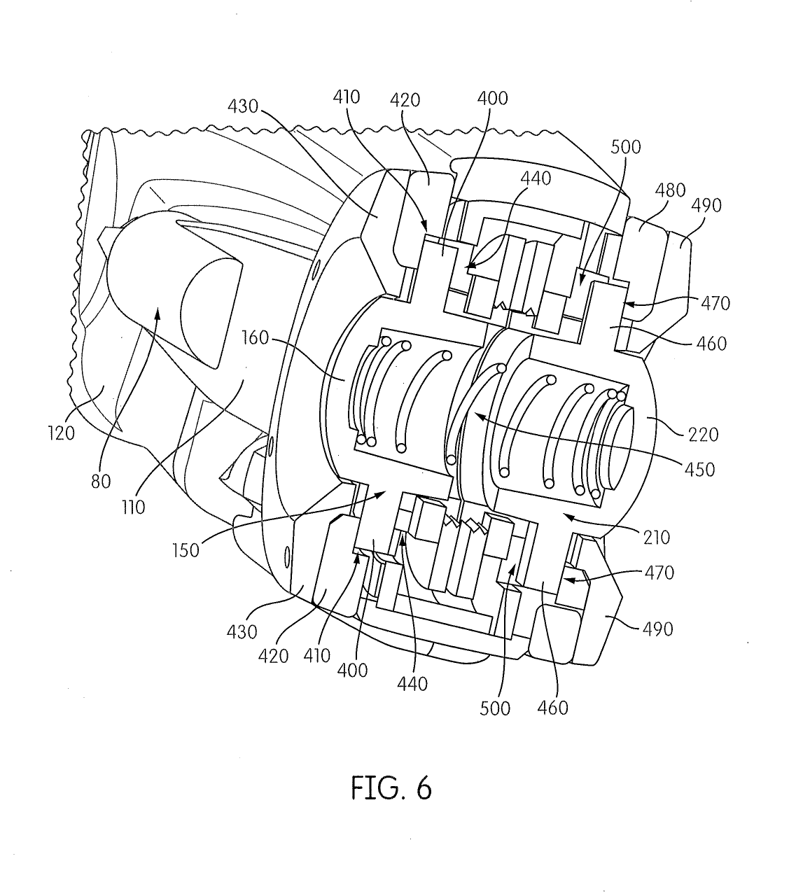

As indicated above, both the pivotable tool 80 and the second pivotable tool 170 of the illustrated embodiment of the multi-tool 10 include a locking actuator (specifically the locking actuator 150 and the second locking actuator 210 respectively), which are configured to lock the pivotable tool 80 and the second pivotable tool 170 into respective locking positions. FIG. 6 illustrates a perspective cross sectional view of the multi-tool 10, illustrating the engagement of components of the locking actuator 150 and the second locking actuator 210.

As shown, the locking actuator 150 associated with the pivotable tool 80 includes a pair of locking tabs 400 coupled to the button 160. While the illustrated embodiment includes a pair of the locking tabs 400, other embodiments may utilize only one locking tab, or may utilize more locking tabs. As shown, the locking tabs 400 are configured to selectively engage locking recesses 410 associated with the pivotable tool 80 when the button 160 is in a first position. Specifically, the locking recesses 410 are formed in a rotatable member 420, which may be annular in shape, and have the support arm 110 of the pivotable tool 80 extending therefrom. It may be appreciated that the locking recesses 410 may be periodically spaced around the rotatable member 420, and sized so as to receive the locking tabs 400 therein, to lock the rotatable member 420, and thus the pivotable tool 80, in one of the plurality of locking positions, associated with engagement between the locking recesses 410 and the locking tabs 400, as described in greater detail below. An annular retaining cap 430 is configured to secure the rotatable member 420 to the housing 20, while exposing the button 160 through the opening therein. As visible in the cross sectional view of FIG. 6, while when the button 160 is in the first position, the locking tabs 400 engage the locking recesses 410. By pressing the button 160 into a second position, however, the locking tabs 400 move out of the locking recesses 410, into disengagement spaces 440, so that the locking tabs 400 do not interfere with rotation of the rotatable member 420.

Further shown in FIG. 6 is that the button 160 is biased into the first button position, where the locking tabs 400 engage the locking recesses 410. As such, when the pivotable tool 80 is being rotated between the plurality of locking positions, when the pivotable tool 80 enters one of the locking positions, the locking tabs 400 will automatically enter into the locking recesses 410 associated with that locking position, locking the pivotable tool 80 in the locking position, until the button 160 is depressed again, to allow the pivotable tool 80 to again move relative to the housing 20. In the illustrated embodiment, the biasing of the button 160 is accomplished by a spring 450. As described in greater detail below, the spring 450 serves as a biasing member for both the button 160 and the second button 220. In other embodiments, however, separate springs or other biasing members may be associated with each of the button 160 and the second button 220.

It may be appreciated that in the illustrated embodiment of the multi-tool 10, the second locking actuator 210 may be functionally identical to the locking actuator 150, however may be structurally mirrored across the multi-tool 10. Specifically, the second locking actuator 150 associated with the second pivotable tool 170 includes a pair of locking tabs 460 coupled to the second button 220. Again, any number of locking tabs may be utilized in various embodiments. The locking tabs 460 are configured to selectively engage locking recesses 470 associated with the second pivotable tool 170 when the second button 220 is in an associated first position. Specifically, the locking recesses 470 are formed in a rotatable member 480, which may be annular in shape, and may have a support arm, such as the first plier handle 190 of the plier embodiment of the second pivot tool 170, extending therefrom. It may be appreciated that the locking recesses 470 may be periodically spaced around the rotatable member 480, and sized so as to receive the locking tabs 460 therein, to lock the rotatable member 480, and thus the second pivotable tool 170, in one of the plurality of locking positions, associated with engagement between the locking recesses 470 and the locking tabs 460, as described in greater detail below. A second annular retaining cap 490 is configured to secure the rotatable member 480 to the housing 20, while exposing the second button 220 through the opening therein. As visible in the cross sectional view of FIG. 6, while when the second button 220 is in the first position, the locking tabs 460 engage the locking recesses 470. By pressing the second button 220 into a second position, however, the locking tabs 460 move out of the locking recesses 470, into associated disengagement spaces 500, so that the locking tabs 460 do not interfere with rotation of the rotatable member 480.

As indicated above, in the illustrated embodiment the spring 450 biases both the button 160 and the second button 220 into associated first button positions (i.e. a first button position and a first second-button position respectively). Accordingly, the second locking actuator 210 is biased so that the locking tabs 460 generally engage the locking recesses 470. As such, when the second pivotable tool 170 is being rotated between the plurality of locking positions, when the second pivotable tool 170 enters one of the locking positions, the locking tabs 460 will automatically enter into the locking recesses 470 associated with that locking position, locking the second pivotable tool 170 in the locking position, until the second button 220 is depressed again, to allow the second pivotable tool 170 to again move relative to the housing 20. While the spring 450 serves as a biasing member for both the button 160 and the second button 220 in the illustrated embodiment, in other embodiments a separate spring or other biasing member may be associated with the second button 220.

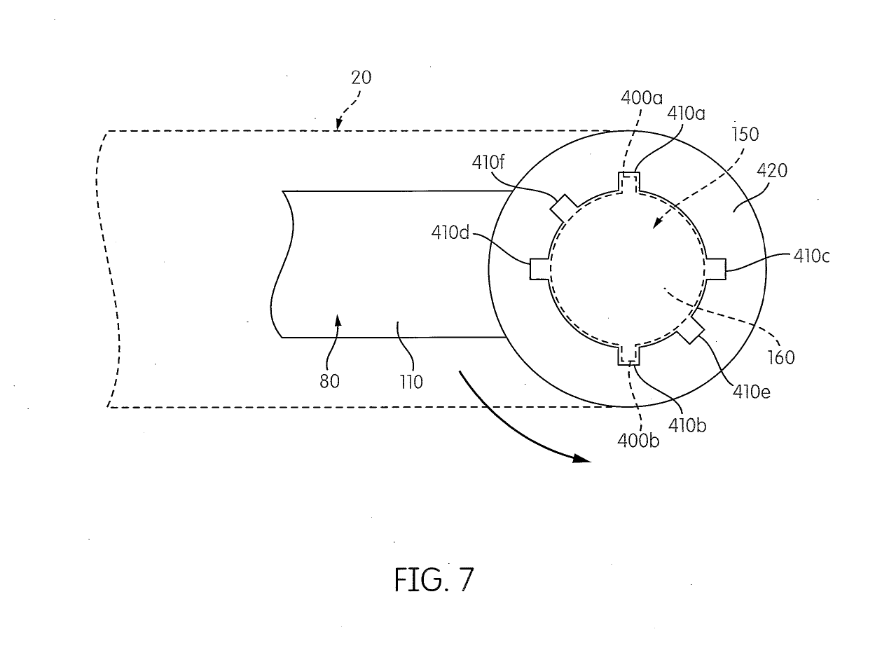

FIG. 7 schematically illustrates the engagement between the locking tabs 400 of the first locking actuator 150, and the locking recesses 410 associated with the pivotable tool 80. Specifically, as shown, the first locking actuator 150 includes a first locking tab 400a and a second locking tab 400b. As indicated above, in other embodiments, more or less of the locking tabs may be utilized. When the pivotable tool 80 is in the first locking position, extending alongside the housing 20, the first locking tab 400a may be received in a first locking recess 410a formed in the rotatable member 420, while the second locking tab 400b is received in the second locking recess 410b. When the button 160 is depressed, so that the locking tabs 400a and 400b move out of the plane of the locking recesses 410a and 410b, the pivotable tool 80 may rotate counter clockwise, until a third locking recess 410c becomes associated with the first locking tab 400a, while a fourth locking recess 410d becomes associated with the second locking tab 400b. It may be appreciated from the schematic view that in this configuration, the pivotable tool 80 is rotated approximately 90 degrees with respect to the orientation of the housing 20. As indicated above, where the locking tabs 400a and 400b are spring biased into the first position, without continuous pressure against the force of the bias, the pivotable tool 80 would then lock at the 90 degree angle with respect to the housing 20.

Further rotation of the pivotable tool 80 when the button 160 is depressed into the second button position (bringing the locking tabs 400 out of engagement with the locking recesses 410) would bring a fifth locking recess 410e into alignment with the first locking tab 400a, while a sixth locking recess 410f comes into alignment with the second locking tab 400b. It may be appreciated that with this alignment, the pivotable tool 80 may form a 135 degree angle with respect to the housing 20. Again, the bias of the locking tabs 400a and 400b would again lock the pivotable tool 80 at the 135 degree angle relative to the housing 20, unless or until pressure against the bias is applied by the user of the multi-tool 10.

Even further rotation of the pivotable tool 80 when the button 160 is depressed into the second button position would bring the second locking recess 410b into alignment with the first locking tab 400a, while the first locking recess 410a comes into alignment with the second locking tab 400b. It may be appreciated that with this alignment, the pivotable tool 80 may extend directly outwards from the housing 20, forming a 180 degree angle with respect to the housing 20. Again, the bias of the locking tabs 400a and 400b would again lock the pivotable tool 80 at the 180 degree angle relative to the housing 20, unless or until pressure against the bias is applied onto the button 160.

While in the illustrated embodiment the locking tabs 400 and the locking recesses 410 are configured to provide four locking positions (including three extended/operative positions for the pivotable tool 80, specifically 90°, 135° and 180°), in other embodiments greater or fewer locking positions are possible. Specifically, in some embodiments the multi-tool 10 may include the first locking position where the work end is received adjacent to the housing 20, the second locking position where the pivotable tool 80 extends from the housing in a fully extended position (i.e. 180° with respect to the housing 20), and a third locking position intermediate to the first and second locking positions. It may be appreciated that in an embodiment containing the second pivotable tool 170, the engagement between the locking tabs 460 and the locking recesses 470 may be analogous (however may be mirrored) to those schematically illustrated in FIG. 7.

As indicated above, in some embodiments the multi-tool 10 may lack the second pivotable tool 170. Alternatively, multiple pivotable tools may be formed on a first side of the housing 20 (e.g., adjacent to the pivotable tool 80). It may be appreciated that the configuration of the pivotable tool 80 and/or the second pivotable tool 170 may vary across embodiments, and in some embodiments may include one or more of a hex key, a screw driver, a wrench, a spanner, a blade, scissors, pliers, a saw, tweezers, a file, a corkscrew, and a nut driver.

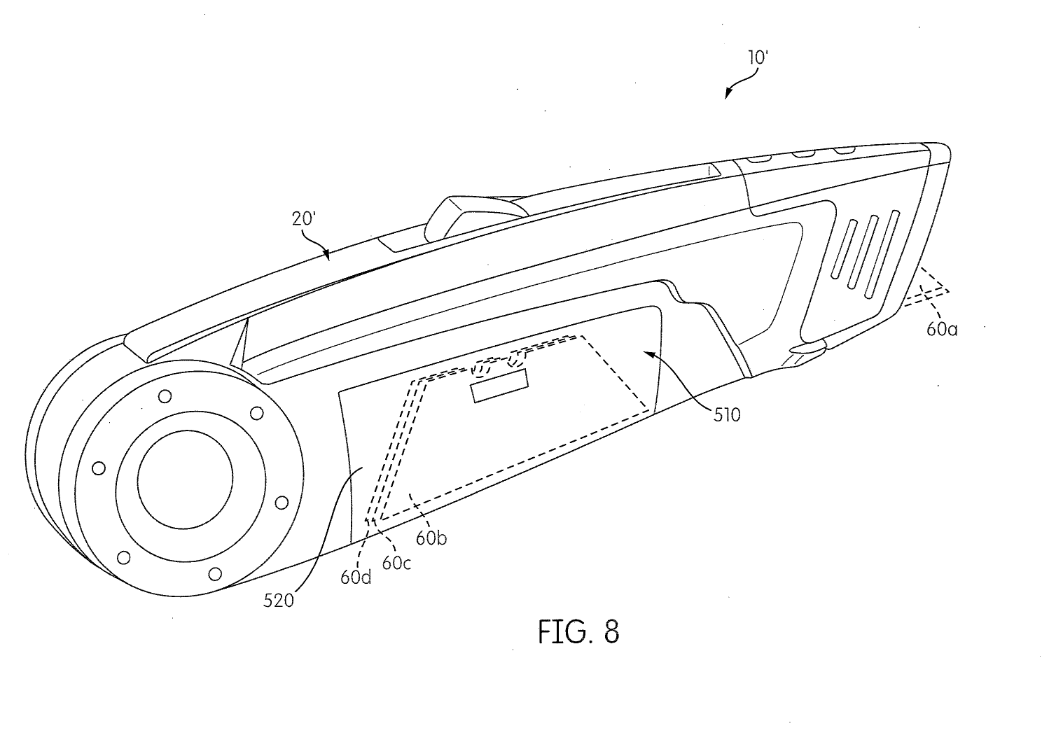

Additionally, in some embodiments the housing 20 may be of a different configuration, lacking the recesses 120 and/or 180, which may allow for 360° rotation of the pivotable tool 80 and/or the second pivotable tool 170. In some embodiments, the housing 20 may be configured to include storage for additional replacement removable utility blades 60 (or replacement snap-off utility blades 350). FIG. 8, for example, illustrates an embodiment of a multi-tool 10′, which may be generally similar to the multi-tool 10, however may lack the second pivotable tool 170. As shown, a housing 20′ of the multi-tool 10′ contains a blade storage chamber 510 configured to store additional removable utility blades. For example, where the operative removable utility blade installed in the multi-tool 10′ is removable utility blade 60a, spare removable utility blades 60b, 60c, and 60d may be stored within the blade storage chamber 510 extending into the housing 20′. While three spare utility blades 60b-d are shown in FIG. 8, in various embodiments the blade storage chamber 510 may be configured to hold greater or fewer spare removable utility blades 60. Also, while in the illustrated embodiment the blade storage chamber 510 includes a chamber door 520 to cover the blade storage chamber 510 to prevent loss of the spare removable utility blades 60, in other embodiments, the blade storage chamber 510 may be generally open, configured to frictionally or slidably receive the additional removable utility blades 60b, 60c, and 60d therein, wherein such blades may be slidably removed to be operably utilized in the multi-tool 10′.

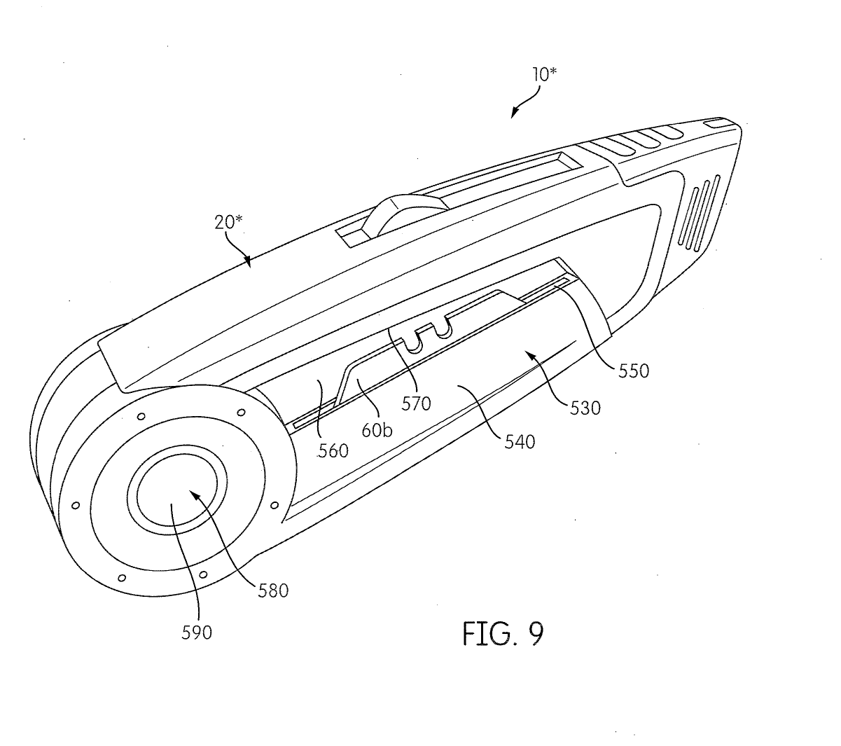

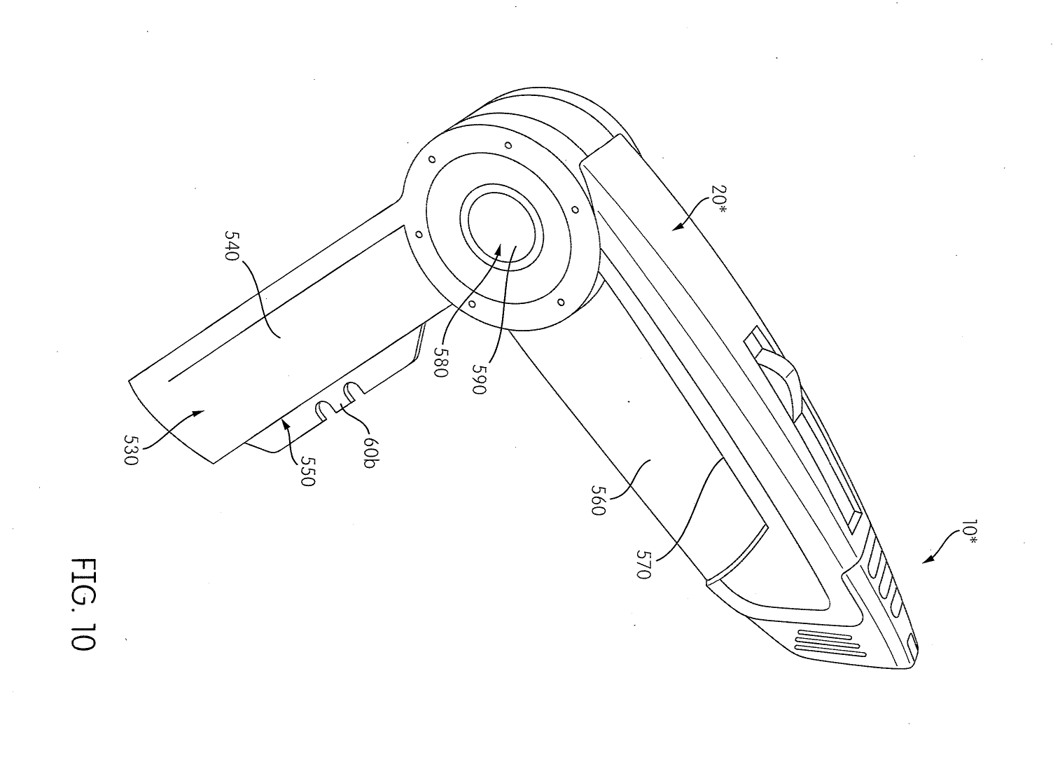

In some embodiments, blade storage may be pivotally mounted to the housing 20 (e.g., embodiments of the pivotable tool 80 and/or the second pivotable tool 170 may comprise the blade storage). For example, FIGS. 9 and 10 illustrate an embodiment of a multi-tool 10*, which may be generally similar to the multi-tool 10. As shown, the multi-tool 10* includes a pivotable blade storage 530, which may be configured to pivot relative to a housing 20* of the multi-tool 10*. In an embodiment, the pivotable blade storage 530 includes a storage body 540 having a slot 550 extending therein. The slot 550 may be configured to receive therein one or more spare removable utility blades 60 (including, for example, the removable utility blade 60b as illustrated). While in some embodiments the storage body 540 may pivot into and out of the housing 20*, in an embodiment, such as that illustrated, the housing 20* may be shaped to include a recess 560 that the pivotable blade storage 530 may be configured to pivot alongside. In a closed configuration of the pivotable blade storage 530, such as that illustrated in FIG. 9, the storage body 540 may be received within the recess 560. Accordingly, in the closed configuration of the pivotable blade storage 530, removal of the spare removable utility blade 60 may be prevented by an opposing surface 570 defining a portion of the recess 560. It may be appreciated that by moving the pivotable blade storage 530 into an opened configuration, such as that illustrated in FIG. 10, the storage body 540 may be moved away from the recess 560, allowing the spare removable utility blade 60 from the slot 550 without interference from the opposing surface 570.

In some embodiments, the multi-tool 10* may include a locking actuator 580, which in an embodiment may be similar to the first locking actuator 150 and/or the second locking actuator 210. As shown, in FIGS. 9 and 10, the locking actuator 580 may be configured to lock the storage body 540 in one of a plurality of locking positions relative to the housing 20*. As shown, engagement or disengagement of the locking actuator 580 in locking the storage body 540 in one of the locking positions may be controlled by a button 590 thereof, which in some embodiments may be similar to the button 160 and/or the second button 220. Other configurations for the locking actuator 580 are also possible in other embodiments. Alternatively, in some embodiments, the pivotable blade storage 530 may lack the locking actuator 580, and may be configured to pivot into and out of the recess 560, where friction, a latch, a detent (e.g., a ball detent), or any other securement may be configured to generally hold the storage body 540 adjacent to or within the housing 20* in the closed configuration for the pivotable blade storage 530, however selectively allowing the pivotable blade storage 530 to pivot relative to the housing 20* into the opened configuration, to allow removal of the spare removable utility blades 60 therefrom. In some embodiments of the multi-tool 10* containing a frictional fit, a detent engagement, or other securement for the pivotable blade storage 530, a gap between the slot 550 and the opposing surface 570 of the recess 560 may facilitate user engagement of the storage body 540 to overcome the frictional fit or similar securement, to allow movement of the pivotable blade storage 530 from the closed configuration to the open configuration.

In various embodiments of the multi-tool 10 (including the multi-tool 10′), it may be appreciated that the components thereof may be of any suitable construction or configuration, including but not limited to metal, plastic, elastomer, wood or combinations thereof. For example, in an embodiment while the housing 20 may be formed of plastic, the pivotable tool 80 and/or the second pivotable tool 170 may be formed of metal. In an embodiment, the housing 20 may be at least partially wrapped in a grip material, including but not limited to rubber. In an embodiment the housing 20 and/or the grip material may include branding information thereon, and in some embodiments may be colored to correspond to a brand's trade dress. In some embodiments, plastic may be formed over a metal structure, so as to increase the strength of the multi-tool 10. Additionally, while in various embodiments described above components of the multi-tool 10 are described as uniform bodies or separate components, in various embodiments the components may be separate assemblies or may be integrally formed or molded. In some embodiments the components may be cut, bent, die pressed, fused, welded, adhered through any suitable adhesive, snap fit together, or interlocked. Additionally, various fasteners may be utilized in various embodiments to combine components into an assembly.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A tool comprising:
a housing;
a slidable blade assembly configured to slidably move between a first position and a second position, the slidable blade assembly including a blade, wherein the blade is stored within the housing when the slidable blade assembly is in the first position, and wherein the blade has at least a portion thereof extending outwardly from the housing when the slidable blade assembly is in the second position;
a pivotable tool pivotally movable relative to the housing, the pivotable tool configured to pivotably move among a plurality of locking positions including a first locking position where a work end of the pivotable tool is received adjacent to the housing; a second locking position where the pivotable tool extends from the housing in a fully extended position; and a third locking position intermediate the first and second locking positions; and
a releasable lock assembly arranged to selectively lock the pivotable tool in the first, second, or third locking positions.

2. The tool of claim 1, wherein the releasable lock assembly comprises a locking actuator configured to selectively allow pivoting movement of the pivotable tool among the plurality of locking positions.

3. The tool of claim 2, wherein the locking actuator comprises a button movable between a first button position and a second button position, wherein when the button is in the first button position, locking tabs engage locking recesses associated with the pivotable tool to prevent pivoting movement of the pivotable tool, while when the button is in the second button position, the locking tabs disengage from the locking recesses to allow said pivoting movement of the pivotable tool.

4. The tool of claim 3, wherein the button is biased into the first button position.

5. The tool of claim 4, wherein the button is biased by a spring.

6. The tool of claim 5, further comprising a second pivotable tool configured to pivotably move among an associated plurality of locking positions, and a second locking actuator configured to selectively allow pivoting movement of the second pivotable tool among the associated plurality of locking positions, wherein the second locking actuator comprises a second button movable between a first second-button position and a second second-button position, wherein when the second button is in the first second-button position, associated locking tabs engage locking recesses associated with the second pivotable tool to prevent pivoting movement of the second pivotable tool, while when the second button is in the second second-button position, the associated locking tabs disengage from the locking recesses associated with the second pivotable tool to allow said pivoting movement of the second pivotable tool.

7. The tool of claim 6, wherein the second button is biased in to the first second-button position.

8. The tool of claim 7, wherein the second button is biased into the first second-button position by the spring.

9. The tool of claim 8, wherein the spring comprises a compression spring extending between the button and the second button.

10. The tool of claim 3, wherein the locking recesses comprise locking recesses associated with the first locking position and the second locking position.

11. The tool of claim 1, wherein in the first locking position, the pivotable tool extends alongside the housing.

12. The tool of claim 1, wherein in the second locking position, the pivotable tool extends at a 180° angle relative to an orientation of the housing.

13. The tool of claim 1, wherein in the third locking position, the pivotable tool extends at a 90° angle relative to an orientation of the housing.

14. The tool of claim 1, wherein the plurality of locking positions further comprises a fourth locking position, intermediate the first and second locking positions.

15. The tool of claim 14, wherein in the fourth locking position, the pivotable tool extends at a 135° angle relative to the orientation of the housing

16. The tool of claim 1, wherein the pivotable tool is selected from the group consisting of: a hex key, a screwdriver, a wrench, a spanner, a blade, scissors, pliers, a saw, tweezers, a file, a corkscrew, and a nut driver.

17. The tool of claim 1, wherein the pivotable tool is a multi-bit screwdriver; the tool further comprising bit storage therein.

18. The tool of claim 17, wherein the bit storage is pivotably mounted to the housing.

19. The tool of claim 18, wherein the bit storage is configured to pivotably move among a plurality of locking positions, wherein said pivotal movement is selectively allowed by the locking actuator.

20. The tool of claim 1, wherein the slidable blade assembly comprises a removable utility blade and a movable blade support.

21. The tool of claim 20, further comprising a blade release button configured to disengage the removable utility blade from the movable blade support.

22. The tool of claim 20, wherein the removable utility blade comprises a trapezoidal utility blade.

23. The tool of claim 20, wherein the removable utility blade comprises a snap-off utility blade.

24. The tool of claim 20, wherein the housing further comprises storage for one or more spare utility blades.

25. The tool of claim 20, further comprising pivotable storage for one or more spare utility blades.

26. The tool of claim 25, wherein the pivotable storage is configured to pivotably move among an associated plurality of locking positions relative to the housing.

27. The tool of claim 26, further comprising an associated locking actuator associated with the pivotable storage, configured to selectively allow pivoting movement of the pivotable storage among the associated plurality of locking positions.
